(19) United States
(12) Patent Application Publication
(10) Pub. No.: US 2026/0021865 A1
(43) Pub. Date: Jan. 22, 2026

(54) QUICK RELEASE STRUCTURE FOR A BICYCLE

(71) Applicant: GLORY WHEEL ENTERPRISE CO., LTD., Taichung City (TW)

(72) Inventor: CHIEN-HAO LEE, Taichung City (TW)

(21) Appl. No.: 18/778,926

(22) Filed: Jul. 20, 2024

(51) Int. Cl. B62K 25/02

(52) U.S. Cl. CPC B62K 25/02; B62K 2206/00

(57) ABSTRACT

A quick release structure has a quick release handle, a shaft, a clamping element, and a clamping member. The shaft has a recess, a cavity, and a resilient member. The recess is defined in an end of the shaft. The cavity is defined in a bottom of the recess. The cavity has a diametrical cross section larger than a diametrical cross section of the recess. The clamping element has two ends. One of the ends is connected with the quick release hand, and the other end extends into the recess. The clamping member is mounted around the clamping element and is engaged with the quick release handle and the shaft.

### FIELD OF INVENTION

The present invention relates to a quick release structure, particularly to a quick release structure for a bicycle to quickly combine a bicycle frame with a wheel.

### BACKGROUND OF THE INVENTION

A conventional quick release structure for a bicycle substantially comprises a quick release hand, a clamping element, and a shaft. A base is formed on an end of the quick release hand, and an inner surface is defined axially in the base. A through hole is axially defined through the shaft. An annular recess is define around an inner surface of the through hole, and a resilient member is mounted in the annular recess. The annular clamping element is an elongated rod having an even diameter. Two ends of the clamping element extend respectively into the inner recess of the quick release handle and the through hole of the shaft. The outer surface of the clamping element abuts against an inner surface of the annular resilient member. With such a structure, the quick release handle can be combined with the shaft by the clamping element for holding a wheel on a bicycle frame in position.

However, for the clamping element being able to being mounted around the shaft, the clamping element should has tolerance to make the clamping element have a diameter smaller than that of the through hole while the clamping element is manufactured. Thus, when a gap is formed between the clamping element and the shaft, the buffering effect and combination stability between the clamping element and the shaft is bad only by the resilient member being mounted around the clamping element. Therefore, noise will be generated by the shaking clamping element buffering against the inner surface of the shaft while the bicycle is riding. Accordingly, to improve the structure is necessary.

To overcome the shortcomings, the present invention tends to provide a quick release structure to mitigate or obviate the aforementioned problems.

### SUMMARY OF THE INVENTION

The objective of the present invention is to provide a quick release structure to improve the question of the noise generated by the shaking clamping element bumping against the inner surface of the shaft due to the tolerance of the clamping element.

To achieve the objective, the present invention provides a quick release structure having a quick release handle, a shaft, a clamping element, and a clamping member. The shaft has a recess, a cavity, an annular groove, and a resilient member. The cavity is defined in an end of the shaft. The recess is defined in a bottom of the cavity. The annular groove is defined in an inner surface of the cavity. The resilient member is mounted in the annular groove, wherein the cavity has a diametrical cross section larger than a diametrical cross section of the recess. The clamping element has two ends. One of the ends of the clamping element is connected with the quick release hand, and the other end of the clamping element extends into the recess. The clamping member is mounted around the clamping element and is engaged with the quick release handle and the shaft.

With such features, when the clamping element is combined with the shaft, the resilient member and the clamping member both can provide a buffering and supporting effect to reduce the influence caused by the tolerance of the resilient member. The combination of the clamping element with the shaft is stable. The noise generated by the shake of the clamping element while the bicycle is riding will be reduced.

### BRIEF DESCRIPTION OF THE DRAWINGS

FIG. 1 is a perspective view of a quick release structure in accordance with the present invention for combining a wheel with a bicycle frame;

FIG. 2 is a cross sectional side view of a first embodiment of a quick release structure in accordance with the present invention;

FIG. 3 is an enlarged cross sectional side view of quick release structure in FIG. 2;

FIG. 4 is an enlarged cross sectional side view of a second embodiment of a quick release structure in accordance with the present invention;

FIG. 5 is an enlarged cross sectional side view of a third embodiment of a quick release structure in accordance with the present invention;

FIG. 6 is an enlarged cross sectional side view of a fourth embodiment of a quick release structure in accordance with the present invention;

FIG. 7 is an enlarged cross sectional side view of a fifth embodiment of a quick release structure in accordance with the present invention; and

FIG. 8 is an enlarged cross sectional side view of a sixth embodiment of a quick release structure in accordance with the present invention.

### DETAILED DESCRIPTION OF THE PREFERRED EMBODIMENTS

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

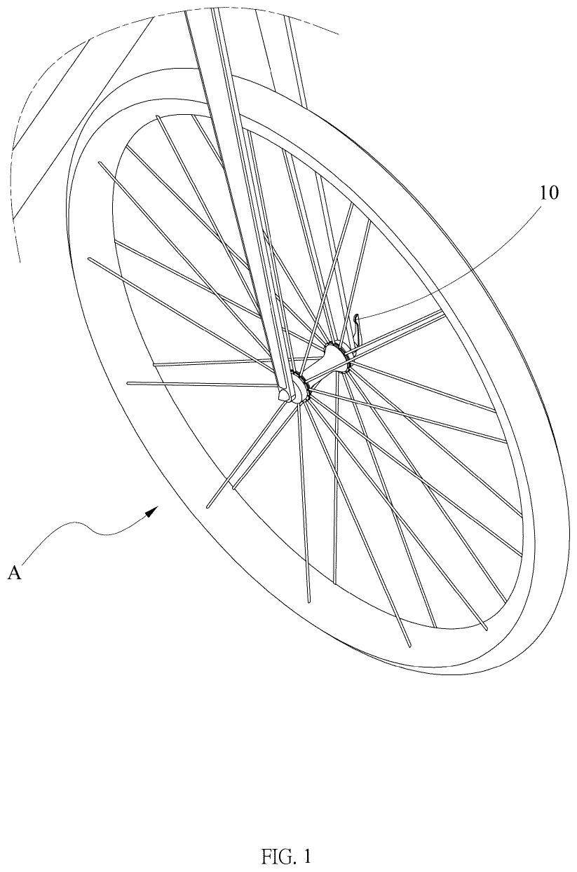

With reference to FIG. 1, a quick release structure for a bicycle in accordance with the present invention is mounted between a frame and a wheel of a bicycle A with rotating the quick release structure, the quick release structure can be detached from the frame, and the wheel can be detached from the frame of the bicycle A. In addition, with rotating the quick release structure in reverse, the wheel can be combined securely with the frame of the bicycle A.

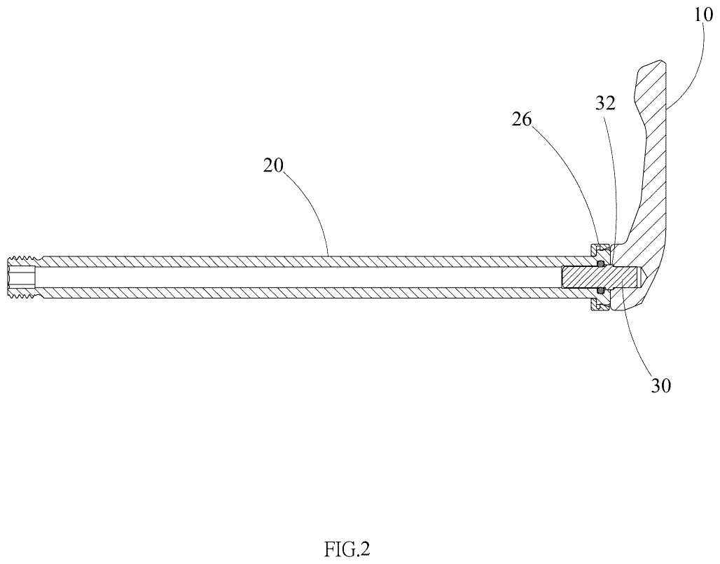

With reference to FIG. 2 and FIG. 3, the quick release structure in accordance with the present invention comprises a quick release handle 10, a shaft 20, and a clamping element 30.

A cavity 24 is defined in an end 201 of the shaft 20. A recess 22 is defined in a bottom of the cavity 24. The cavity 24 has a diametrical cross section larger than a diametrical cross section of the recess 22. An annular groove 221 is defined around an inner surface of the cavity 22. An annular resilient member 26 is mounted in the annular groove 221.

The clamping element 30 has two ends, one of the two ends is combined with an end of the quick release handle 10, and the other end extends into the cavity 22. Wherein, a maximum diameter of the clamping element 30 is smaller a maximum diameter of the recess 22. Thus, the clamping element 30 can detachably extend into the recess 22. When the end of the clamping element 30 is held in the recess 22, the outer surface of the clamping element 30 abuts against the inner surface of the resilient member 26. At least one clamping member 32 is formed integrally on the clamping element 30. When the end of the clamping element is held in the recess 22, the outer surface of the clamping member 32 abuts against the inner surface of the cavity 24.

With such an arrangement, when the clamping element 30 is combined with the shaft 20, two contact supporting points are formed between the clamping member 30 and the shaft 20. One of the supporting points is at the resilient member 26, and the other supporting point is at the fitness of the diameter of the clamping member 24 with the cavity 24. The two supporting points can improve the stability of the combination of the clamping element 30 and the shaft 20 to reduce the noise generated by shake of the clamping element 30 mounted on the bicycle A and abutting with the inner surface of the recess 22 while the bicycle is riding. In addition, because the clamping element 30 abuts against the cavity 24 by the clamping member 32, the wear caused by the shake of the clamping element 30 can also be reduced to prolong the useful life of the quick release structure.

In another embodiment, multiple clamping member 32 can be formed on the outer surface of the clamping element 30.

With reference to FIG. 3, a base 12 is formed on an end of the quick release handle 10, and a base recess 121 is defined in a side 122 of the base 12. An abutting flange 14 is formed between the base recess 121 and the end 122. At least parts of the two sides of the clamping member 32 are held respectively in the cavity 24 and the base recess 121. And one of the sides of the clamping member 32 abuts against the abutting flange 14.

The diametrical cross section of the clamping member 32 has an even diameter. The outer surfaces of the two sides of the clamping member 32 abut respectively against the inner surface of the cavity 24 and the inner surface of the base recess 121. On side of the clamping member 32 abuts against the abutting flange 14 to keep the clamping element 30 from axially moving while the clamping element 30 is assembled with the shaft 20. Accordingly, the clamping element 30 can be combined with the quick release handle 10 and the shaft 20 in stable.

A limitation recess 34 is defined in the outer surface of the clamping member 32, and the inner surface of the limitation recess 34 can abut against the inner surface of the resilient member 26. A limitation effect can be provided to the resilient member 26 by the limitation recess 34 in cooperation with the annular groove 221 to keep the resilient member 26 to move arbitrarily.

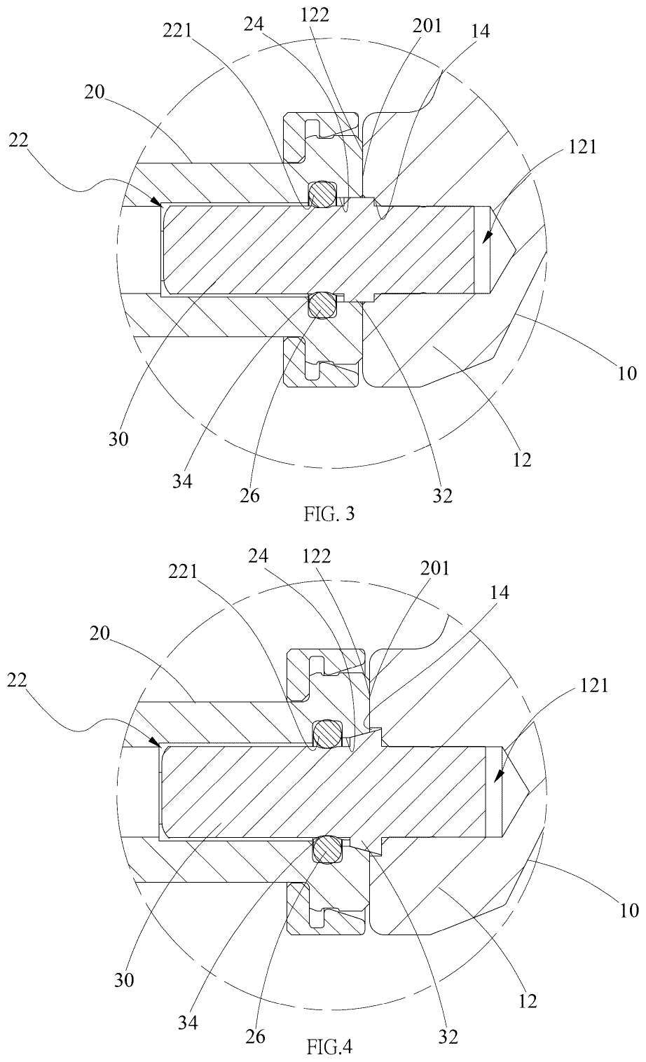

With reference to FIG. 4, a diameter defined by an outer surface of the clamping member 32 is gradually decreased toward the cavity 24 to define an inclined surface, and the cavity 24 has a shape corresponding to the inclined surface on the clamping member 32 in shape. With such an arrangement, the inclined surfaces of the clamping member 32 and the cavity 32, the clamping member 32 can be smoothly put into the cavity 24 along the inclined surfaces to make the shaft 20 be combined with the clamping element 30 easily. With the differences of the diameters of the clamping member 32, the clamping element 32 can be prevent from axial movement.

With reference to FIG. 5, in the third embodiment, a holding recess is defined in the end 121 of the base 12 on the quick release handle 10, and the holding recess 16 has a bottom surface 142. At least parts of two sides of the clamping element 30 are held respectively in the recess 22 and the holding recess 16. Preferably, the outer surfaces of two sides of the clamping member 32 abut respectively against the inner surface of the cavity 24 and the inner surface of the holding recess 16. One side of the clamping member 32 abuts against the bottom surface 142 of the holding recess 16. The clamping member 32 is mounted around the clamping element 30 to increase the diameter of the clamping element 30. With the clamping element 30 extending toward the quick release handle 10 and the shaft 20, the combination strength between the clamping element 30 with the quick release handle 10 and the shaft 20 can be improved. The clamping member 32 may be made of a hard or a soft material. The hard material means metal. The soft material may be Nitrile Butadiene Rubber (NBR), Thermo-Plastic-Rubber material, TPR, or silicone. The soft material can improve the buffering effect of the clamping member 32 and can reduce noise.

With such an arrangement, when the clamping element 30 is combined with the shaft, at least two contact supporting points are formed between the clamping member 30 and the shaft 20. One of the supporting points is at the resilient member 26 with a buffering effect, and the other supporting point is at the fitness of the diameter of the clamping member 24 with the cavity 24 with a buffering effect. The two supporting points can improve the stability of the combination of the clamping element 30 and the shaft 20 to reduce the noise generated by shake of the clamping element 30 mounted on the bicycle A and abutting with the inner surface of the recess 22 while the bicycle is riding. In addition, because the clamping element 30 abuts against the cavity 24 by the clamping member 32, the wear caused by the shake of the clamping element 30 can also be reduced to prolong the useful life of the quick release structure.

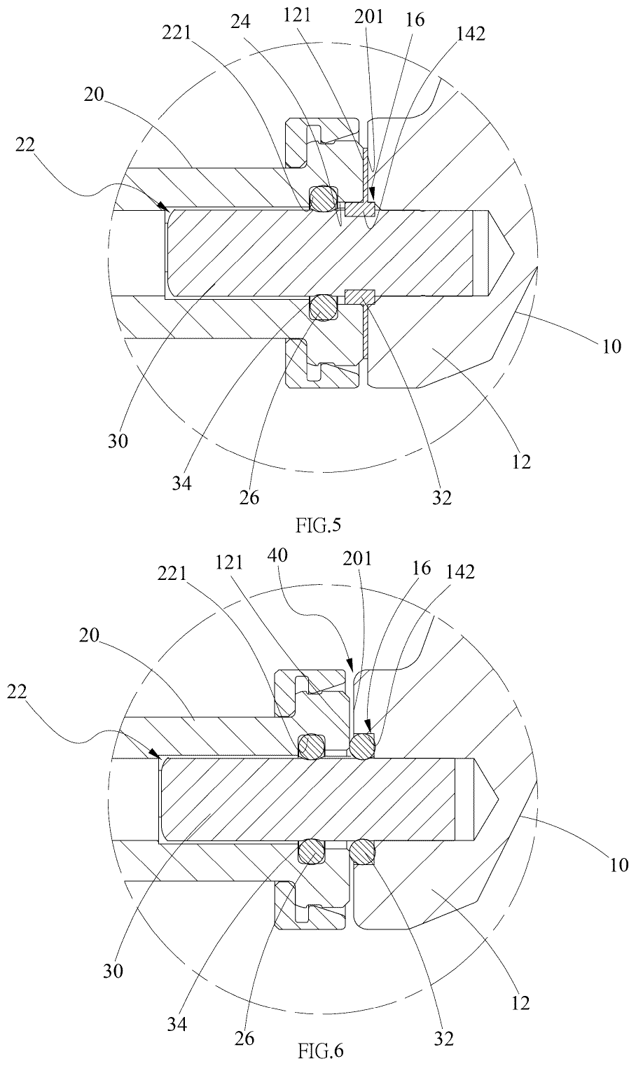

With reference to FIG. 6, in the fourth embodiment, the holding recess 16 is defined in the end face 101 to hold the clamping member 32 in the holding recess 16. This means that the clamping member 32 is not hold in the shaft 20. Two sides of the clamping member 32 abut respectively against the end 201 of the shaft 20 and the bottom surface 14 of the holding recess 16. Preferably, at least a part of the clamping member 32 protrude axially out of the holding recess 16. Thus, when the clamping member 32 is held in the holding recess 16 and the quick release handle 10 is combined with the shaft 20 via the clamping member 32, a gap 40 is defined between the quick release handle 10 and the shaft 20.

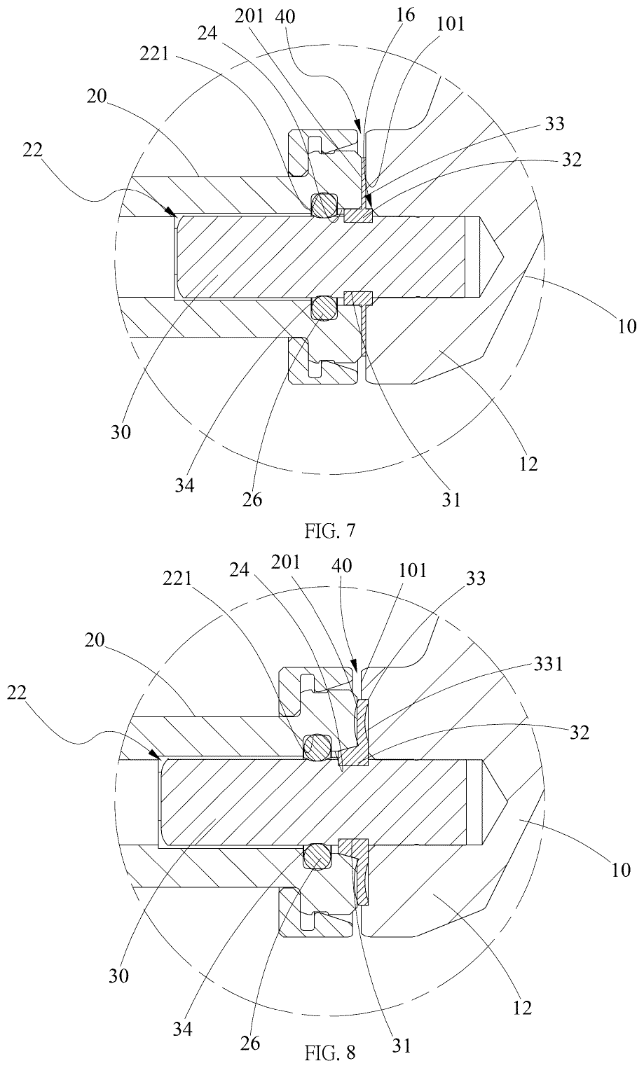

With reference to FIG. 7, the clamping member 32 is mounted around the clamping element 30, an extension portion 33 is formed radially on a part of an outer surface of the clamping member 32. When one end of the clamping element 30 is held in the recess 22, the outer surface of the clamping element 30 abuts against the inner surface cavity 24. With the clamping effect of the resilient member 26, the outer surface of the clamping member 32 abuts against the inner surface of the cavity. Two sides of the extension portion 33 abut respectively against the corresponding ends of the quick release handle 10 and the shaft 20.

In addition, the extension portion 33 protrudes radially from a middle of the clamping member 32. When the clamping element 32 is in being assembled, two ends of the clamping member 32 are held respectively in the cavity 24 and the holding recess 16. A longitudinal length of the extension portion is smaller than an axial length of the clamping member 32. The clamping member 32 may be made of a hard or a soft material. The hard material means metal. The soft material may be Nitrile Butadiene Rubber (NBR), Thermo-Plastic-Rubber material, TPR, or silicone.

With such an arrangement, the present invention has advantages as follows:

First, when the clamping element 30 is assembled with the shaft 20, two contact supporting portions are formed between the clamping element 30 and the inner surface of the shaft 20. One portion is at the resilient member 24 with a buffering effect, and the other portion is at the clamping member 32 mounted around the clamping element 30 and fitting with the cavity 24 with a buffering effect. The two supporting portions can improve the stability of the combination between the clamping element 30 and the shaft 20 to reduce the influence caused by the tolerance of the clamping element 30. The noise generated by shake of the clamping element 30 while the bicycle is riding can be reduced.

Second, the extension portion 33 can increase the contact area between the clamping member 32 with the quick release handle 10 and the shaft 20. With the soft clamping member 32, a shock-absorbing effect can be improved. A friction can also be provided to decrease a rotation force between the quick release hand 10 and the shaft 20.

In addition, an annular recess 31 is defined around the outer surface of the clamping element 30 to hold the clamping member 32 in the annular recess 31. The inner surface of the clamping member 32 abuts against an inner surface of the annular recess 31, such that the position of the clamping member 32 can be limited.

With reference to FIG. 8, in the sixth embodiment, a holding recess 16 is defined in the end face 101 on the quick release handle. The holding recess 16 has a cross sectional shape corresponding to the shape of the clamping member 32 and at least a part of the extension portion 33 in shape.

In this embodiment, the extension portion 33 is formed radially on one end of the clamping member 32. When the clamping member 32 is mounted around the clamping element 30 and is held in the holding recess, at least a part of the extension portion 33 protrudes axially out of the holding recess 16. The side of the extension portion 33 facing the shaft 20 abuts against the end 201 of the shaft 20. Accordingly, after the quick release handle 10 is assembled with the shaft 20 with the clamping member 32, a gap 40 is defined between the quick release handle 10 and the shaft 20. Thus, the base 12 on the quick release handle 10 is kept from be in contact directly with the shaft 20 to prevent the possibility of the contact between the quick release handle 10 and the shaft 20 to reduce the contact wear between the quick release handle 10 and the shaft 20. The useful life of the quick release structure in accordance with the present invention can also be prolonged.

Furthermore, the diameter of the cavity 24 are gradually increased toward the end of the shaft 20 to make the cavity 24 have a conical shape with an inclined surface. The outer surface of the clamping member has shape corresponding to the conical cavity 24 and also has an inclined surface. With the inclined surfaces, the clamping element 30 can be easily combined with the shaft 20, and the stability of the combination of the clamping member 32 and the shaft 20. The clamping member 32 can also be kept from axial movement by the difference of diameters of the clamping member 32.

With such an arrangement, after the clamping member is held in the holding recess 16, a part of the clamping member 32 protrudes out from the holding recess 16. With the blocking effect of the extension portion 33, the end face 101 is kept from being in contact with the end 201 of the shaft 20 to further reduce the influence of the contact wear between the quick release handle 10 and the shaft 20. The contact wear between the quick release handle 10 and the shaft 20 can also be reduced to prolong the useful life of the quick release structure in accordance with the present invention.

In addition, the extension portion 33 may be curved and has a curve segment 331 protruding out of the holding recess 16. It is noted, at least a part of an edge of the extension portion 33 protrudes out from the holding recess 16. When the clamping member 32 is combined with the shaft 20 and the quick release handle 10, the shaft 20 presses against the curved segment 331 protruding out of the holding recess 16 to radially deform the extension portion 33, such that an abutting force is generated between the edge of the extension portion 33 and the holding recess 16. Thus, the abutting force between the extension portion 33 and the quick release handle 10 can be improved, and the combination stability between the quick release handle 10 and the shaft 20 can also be improved. The wear or noise caused by the contact or bumping between the quick release handle 10 and the shaft 20 can be reduced.

The side of the extension portion 33 facing the quick release handle 10 may be curved, such that at least a part of an edge of the extension portion 33 protrudes out of the holding recess 16. Thus, when the clamping member 32 is combined with the shaft 20 and the quick release handle 10, the extension portion 33 is radially deformed to increase the abutting effect between the extension portion 33 and the holding recess 16.

In another embodiment, the holding recess 16 has an inner surface inclined toward an opening in the end face 101, such that a bottom of the holding recess 16 has a diameter larger than that of the holding recess 16 at the opening. Accordingly, when the extension portion 33 is pressed to be radially deformed, the edge of the extension portion 33 will be deformed toward the bottom of the holding recess along the inclined arrangement of the holding recess 16. In addition, a limitation effect can be provided by the diameter differences of the bottom and the opening of the holding recess 16.

What is claimed is:

1. A quick release structure for a bicycle comprising:
a quick release handle;
a shaft comprising
a cavity defined in an end of the shaft;
a recess defined in a bottom of the cavity;
an annular groove defined in an inner surface of the cavity; and
a resilient member mounted in the annular groove, wherein the cavity has a diametrical cross section larger than a diametrical cross section of the recess;
a clamping element having two ends, one of the ends of the clamping element connected with the quick release hand, and the other end of the clamping element extending into the recess; and
at least one clamping member mounted around the clamping element and engaged with the quick release handle and the shaft.

2. The quick release structure as claimed in claim 1, wherein when the clamping element is held in the recess in the shaft, an outer surface of the clamping element abuts against an inner surface of the resilient member and an outer surface of the resilient member abuts against an inner surface of the cavity.

3. The quick release structure as claimed in claim 2, wherein a base recess is defined in the quick release handle and at least parts of two sides of the clamping member are held respectively in the cavity and the base recess.

4. The quick release structure as claimed in claim 1, wherein a holding recess is defined in an end of the quick release handle, and a part of the clamping member abuts against an inner surface of the holding recess;
when the clamping element is held in the recess in the shaft an outer surface of the clamping element abuts against an inner surface of the resilient member and at least part of the clamping member abuts against the shaft.

5. The quick release structure as claimed in claim 4, wherein at least a part of the clamping member axially protrudes out of the holding recess.

6. The quick release structure as claimed in claim 5, wherein a diameter defined by an outer surface of the clamping member is gradually decreased toward the recess to define an inclined surface, and the cavity has a shape corresponding to the inclined surface in shape.

7. The quick release structure as claimed in claim 1, wherein an extension portion is formed radially on a part of an outer surface of the clamping member;
when an of the clamping element is held in the recess, an outer surface of the clamping element abuts against an inner surface of the resilient member and two sides of the extension portion abut respectively against the quick release handle and the shaft.

8. The quick release structure as claimed in claim 7, wherein an annular recess is defined in an outer surface of the clamping element to hold the clamping member inside, and an inner surface of the clamping member abuts against an inner surface of the annular recess.

9. The quick release structure as claimed in claim 8, wherein a holding recess is defined in the quick release handle at a position corresponding the end of the shaft;
at least parts of two ends of the clamping member are held respectively in the cavity and the holding recess and outer surface of the two sides of the clamping member abut respectively against an inner surface of the cavity and an inner surface of the holding recess.

10. The quick release structure as claimed in claim 9, wherein the extension portion protrudes radially from a middle of the clamping member.
